(19) United States
(12) Patent Application Publication
(10) Pub. No.: US 2026/0346281 A1
(43) Pub. Date: Nov. 5, 2026

(54) Impulse sprinkler with system for adjusting the range angle as well as the adjustment method thereof

(71) Applicant: Komet Austria GmbH, Lienz (AT)

(72) Inventor: Arno Drechsel, Lienz (AT)

(21) Appl. No.: 19/130,923

(22) PCT Filed: Nov. 16, 2023
(86) PCT No.: PCT/IB2023/061596

§ 371 Date: May 16, 2025

(30) Foreign Application Priority Data
Nov. 22, 2022 (IT) 102022000024006

(51) Int. Cl. B05B 3/14; A01G 25/16; B05B 12/00; B05B 13/00; G01D 5/14

(52) U.S. Cl. CPC B05B 3/14; A01G 25/16; B05B 12/004; B05B 13/005; G01D 5/14

(57) ABSTRACT

An impulse sprinkler with an adjustment system for adjusting the range angle includes a spout tube connected to a pressurized water supply line for generating a jet, and a joint adapted to allow the inclination of the spout tube. The adjustment system includes a drive associated with the joint to determine the inclination of the spout tube, and an electronic control system that is selectively connected to the drive to allow a continuous change in the range angle. A method for adjusting the range angle of the impulse sprinkler is also disclosed.

### FIELD OF THE INVENTION

The present invention generally relates to the technical field of irrigation systems for farming and industrial purposes and it particularly relates to an impulse sprinkler with system for adjusting the range angle.

The invention also relates to a method for adjusting the range angle in an impulse sprinkler.

### BACKGROUND ART

Impulse sprinklers are known for farming and/or industrial purposes connected to a pressurized liquid supply line and adapted to distribute a jet of such liquid on a land portion to be irrigated.

Impulse sprinklers are generally rotatable around the vertical axis thereof and comprise a spout tube for a pressurized liquid jet and elements of mechanical limit switches adapted to delimit an angular sector corresponding to an angular portion of the land to be irrigated.

Furthermore, these sprinklers comprise an oscillating arm driven by the liquid jet exiting from the spout tube and adapted to promote the rotation of the spout tube and a reversing lever coupled to the oscillating arm adapted to alternatively interact with one of the two stops to periodically reverse the direction of rotation of the spout tube within a swinging angle defined by the pair of mechanical limit switches.

This type of impulse sprinklers can be installed on fixed-type systems, but it is typically installed on board a self-propelled trolley, adapted to be moved over the land to be irrigated in a generally straight direction in order to wet a broader surface area of land.

A first drawback of such sprinklers lies in the fact that they do not allow a controlled or automatic adjustment of the range angle before or during the irrigation.

As a matter of fact, the waterjet flowing out from the spout tube may be deviated by the action of the wind which changes, even significantly, the range of the sprinkler, with resulting inadequate irrigation.

In order to overcome these drawbacks, there have been developed systems for the automatic adjustment of the range angle of the spout tube of a sprinkler which allow to change such angle avoiding the action of the operator or interrupting the operation of the sprinkler.

Generally, such systems provide an apparatus for measuring and recording the strength and/or direction of the wind providing, in output, electrical signals adapted to control the inclination angle of the spout tube.

A drawback of such prior art systems lies in the fact that the means for adjusting the range angle are not capable of precisely adjusting the range angle.

Still, another drawback lies in the fact that such prior art systems are not provided with safety means adapted to change the angle should the set range angle be exceeded or with safety means adapted to shut off the irrigation should the sprinkler tip over.

### TECHNICAL PROBLEM

In the light of the prior art, the technical problem addressed by the present invention is to allow a precise automatic adjustment of the range angle of an impulse sprinkler.

### SUMMARY OF THE INVENTION

The object of the present invention is to solve the aforementioned problem by providing an impulse sprinkler with a system for adjusting the range angle which is highly effective and cost-effective.

A particular object of the present invention is to provide an impulse sprinkler of the type indicated above which allows to operate automatically.

Another object of the present invention is to provide an impulse sprinkler of the type indicated above which has an automatic safety system adapted to intervene should the set range angle be exceeded.

A further object of the present invention is to provide an impulse sprinkler of the type indicated above which comprises components that are simple and readily available on the market.

The objects mentioned above and others which will be more apparent hereinafter, are attained by an impulse sprinkler with a system for adjusting the range angle, according to claim 1, wherein the sprinkler comprises a spout tube connected to a pressurized water supply line for generating a jet, and a joint adapted to allow the inclination of the spout tube.

The system for adjusting the range angle of the impulse sprinkler comprises drive means coupled to the joint so as to determine the inclination angle of the spout tube and there are provided electronic control means which are selectively connected to the drive means to allow the actuation thereof.

In a first embodiment of the invention, the electronic control means for adjusting the inclination of the spout tube comprise proximity sensors operatively connected to the drive means.

In a second embodiment, the control means comprise a first and a second magnetometer positioned at the joint and the spout tube and spaced apart.

In a third embodiment, the drive means comprise an encoder.

Advantageously, the electronic control means comprise an accelerometer and/or gyroscope configured to shut off the pressurized water supply to the spout tube when the latter tips over and/or has a range angle different from the one set in the control means.

This combination of characteristics allows to obtain a sprinkler with control and adjustment of the range angle and with a safety system should the sprinkler tip over or exceed the set range angle.

The invention also relates to a method for adjusting the range angle in an impulse sprinkler, according to claim 10.

Advantageous embodiments of the invention are attained according to the dependent claims.

### BRIEF DESCRIPTION OF THE DRAWINGS

Further characteristics and advantages of the invention will be more apparent in the light of the detailed description of a preferred but not exclusive embodiment of an impulse sprinkler with system for adjusting the range angle like the one mentioned above, shown by way of non-limiting example with reference to the drawings below, wherein:

FIG. 1 is a perspective view of the impulse sprinkler according to the invention;

FIG. 2 is an exploded perspective view of the sprinkler of FIG. 1;

FIGS. 3 and 4 are lateral cross-sectional views of the sprinkler of FIG. 1 respectively in a first and second operative position;

FIG. 5 is a lateral cross-sectional view of a detail of the sprinkler of FIG. 3 in a first embodiment;

FIG. 6 is a lateral cross-sectional view of a detail of the sprinkler of FIG. 3 in a second embodiment;

### DETAILED DESCRIPTION OF A PREFERRED EMBODIMENT

With particular reference to the figures, there is shown an impulse sprinkler, indicated in its entirety with reference numeral 1 configured to distribute a liquid, for example water, on a determined surface area of the land to be irrigated.

In a per se known manner, the sprinkler 1 comprises a spout tube 2 defining and irrigation axis R and connected to a pressurized water supply line for generating a jet, not shown in the figures, with a joint 3 rotatable around a substantially vertical axis Z.

Advantageously, the joint 3 comprises a fixed part 4 coupled to the liquid supply line and a rotatable part 5 coupled to the spout tube 2 to promote the rotation thereof.

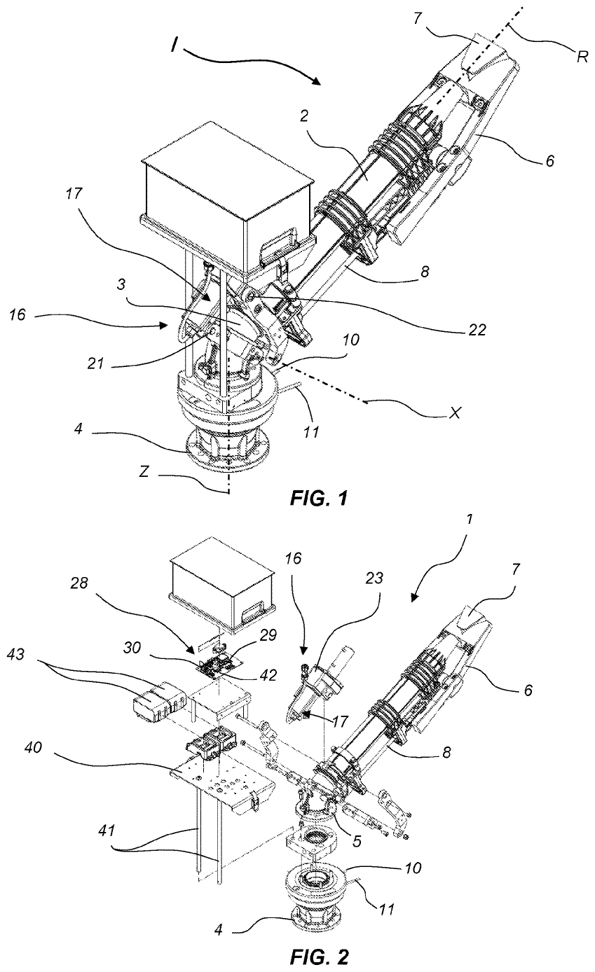

Furthermore, in a per se known manner, the sprinkle 1 comprises an oscillating arm 6 driven by the pressurized liquid jet to determine the automatic rotation of the spout tube 2 with periodic reversal of the direction of rotation, as better shown in FIGS. 1-2.

In particular, the oscillating arm 6 comprises a deflector 7 adapted to interfere with liquid jet flowing out from the spout tube 2 so as to induce the rotation thereof, as well known to the person skilled in the art, and a rod 8 having an end 9 facing towards the joint 3 of the sprinkler 1.

The sprinkler 1 comprises a pair of mechanical limit switches 10, 11 which can be associated with the fixed part 4 of the joint 3 in predetermined angular positions with respect to the vertical rotation axis Z, so as to define an angular irrigation sector defined by a swinging angle, not shown in the figures.

As better shown in FIG. 2, each of the mechanical limit switches 10, 11 is formed on a respective annular element 12, 13 coupled to the fixed part 4 of the joint 3 and which protrudes radially outwards.

In a per se known manner, the annular elements 12, 13 are mutually rotatable to change the angular position of the mechanical limit switches 10, 11 and therefore the width of the irrigation sector, not shown in the figures.

Suitably, the sprinkler 1 comprises a reversing lever 14 for reversing the rotation which can be operatively coupled to the oscillating arm 6, in particular to the end 9 of the rod 8 facing towards the joint 4.

The reversing lever 14 is adapted to interact with the pair of mechanical limit switches 10, 11 during the rotation of the spout tube 2 so as to reverse the direction of rotation within the irrigation sector.

In particular, the contact of the reversing lever 14 with a respective mechanical limit switch 10 will cause the oscillation of the oscillating arm 6 with a determined direction of rotation. This movement of the oscillating arm 6 will promote the rotation of the spout tube 2 around the vertical axis Z in the in the clockwise or anticlockwise direction.

Furthermore, the contact of the reversing lever 14 with the other mechanical limit switch 11 will cause the oscillation of the oscillating arm 6 in the opposite direction and the resulting reversal of the direction of rotation of the spout tube 2 within the irrigation sector.

Therefore, following the interaction with one of the two mechanical limit switches 10, 11, the reversing lever 14 changes, through the rod 8 operatively associated therewith, the position of the deflector 7 so that the latter interferes with the liquid jet on an opposite side, therefore changing the direction of rotation of the spout tube 2.

It should be observed that the sprinkler 1 described heretofore, provided with the reversing lever 14 on the rod 8 interacting with the two mechanical limit switches 10, 11, it has the same characteristics as a sprinkler known to the person skilled in the art.

Advantageously, the impulse sprinkler 1 comprises a joint 15 adapted to allow the vertical inclination of the spout tube 2 around a substantially horizontal axis X, as better shown in the figures. Therefore, the rotation of the spout tube 2 around the horizontal axis X allows to change the range angle α of the sprinkler 1.

Furthermore, there is present a system 16 for adjusting the range angle α which comprises drive means 17 coupled to the joint 15 to determine the inclination of the spout tube.

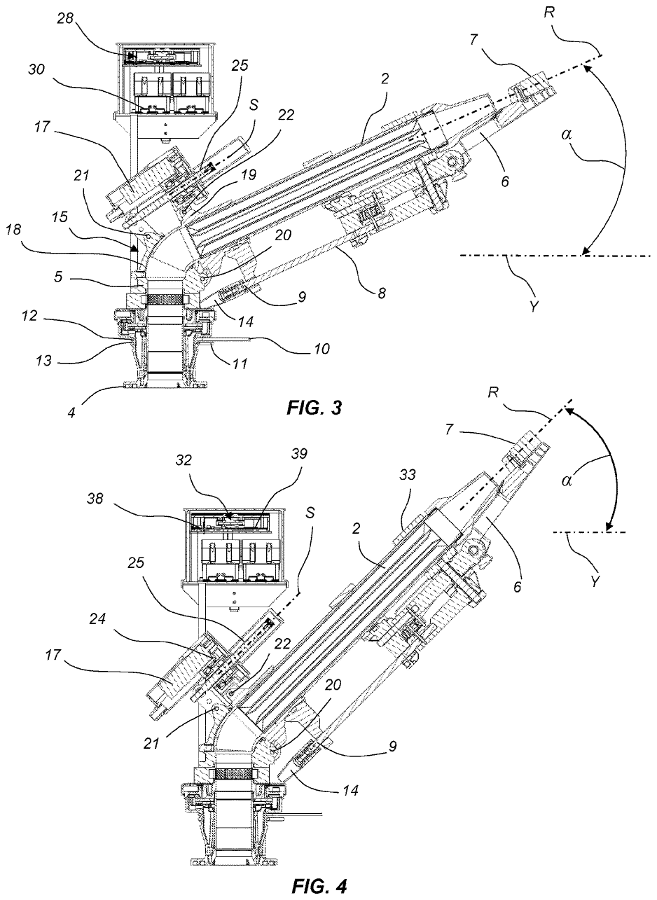

Hereinafter, the expression “range angle α” of the sprinkler 1, will be used to indicate the angle comprised between the axis R of the spout tube 2 and a horizontal axis Y coplanar to the axis R, as shown in FIGS. 3-4.

In particular, the joint 15 comprises a first tubular portion 18 and a second tubular portion 19 respectively connected to the supply line and to the spout tube 2, as better shown in FIGS. 3-4.

In an alternative embodiment of the invention, not shown in the figures, the tubular portions 18, 19 may be suitably designed as a ball joint or socket joint so as to allow a multiple direction rotary movement to the tubular portion 19.

In the preferred embodiment of the sprinkler 1, shown in the figures, the tubular portions 18, 19 are slidable with respect to each other and they are pivoted with respect to each other to rotate around a pin 20 coaxial to the horizontal axis X.

In this configuration, the drive means 17 comprise a pair of ends 21, 22 respectively connected to the first 18 and second tubular portion 19.

Therefore, the activation of the drive means 17 allows the mutual approaching or moving away of the pair of ends 21, 22 with resulting rotation of the tubular portions 18, 19 around the pin 20 and the vertical inclination of the spout tube 2 around the horizontal axis X.

In the preferred embodiment of the invention, shown in the figures, the drive means 17 comprise a motor 23 of the stepper type connected to a gear 24 movable along a threaded member or worm screw 25 having a sliding axis S coplanar to the axis R of the spout tube 2.

The threaded member 25 comprises a first end 25A facing towards the joint 3 and a second end 25B facing towards the deflector 7.

Therefore, the first end 25A is coupled to the end 21 of the first tubular portion 18 and the motor 23 is coupled to the end 22 of the second tubular portion 19 so that the sliding of the gear 24 along the threaded member 25 allows the inclination of the spout tube 2 Preferably, the threaded member 25 and the motor 23 are coupled to the respective ends 21, 22 through respective collars 26, 27 interacting with the pin 20, as shown in FIG. 2.

Furthermore, the threaded member 25 is at least partially contained in a box-like member 25C.

In an alternative embodiment of the invention, not shown in the figures, the drive means 17 may comprise a motor splined to the pin 20 to bring the second tubular portion 19 to the first portion 18, or vice versa.

Furthermore, there are provided electronic control means, indicated in their entirety with reference numeral 28, selectively connected to the drive means 17 so as to allow the actuation thereof and allow a continuous change in the range angle α.

Suitably, the electronic control means 28 comprise an electronic storage unit 29 adapted to store the value of at least one range angle α which can be set by the user or by an irrigation map depending on the geographical position of the sprinkler 1 on the mapped land.

Obviously, the information which can be stored in the memory unit 29 may be transferred by the user through an RFD, WiFi, Bluetooth or microSD interface module, or through LTE, UMTS or GSM networks in a manner per se known to the person skilled in the art.

By way of example, the irrigation map and/or the range angle α may be suitable to be uploaded into the electronic memory unit 29 by the operator through a web application provided to the user.

Furthermore, the control means 28 comprise at least one central microprocessor unit 30 and a plurality of sensors 31-39 adapted to determine the position of the spout tube 2, as better described below.

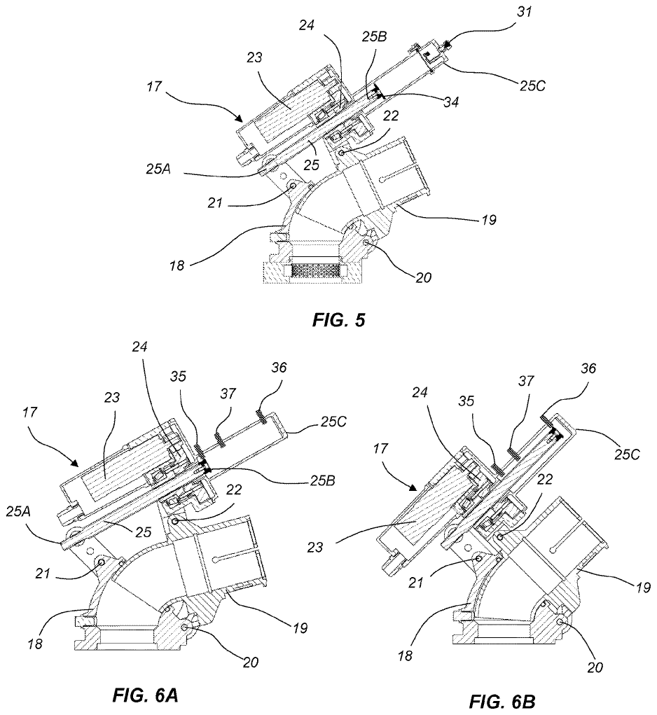

In a first embodiment of the sprinkler 1, shown in FIG. 5, the control means 28 comprise at least one proximity sensor 31 configured to detect the position of the threaded member 25 with respect to the drive means 17 and to measure the range angle α by means of the microprocessor 30.

The proximity sensor 31 may comprise a laser emitter positioned close to the drive means 17, more precisely at a fixed end of the box-like member 25C, and a reflector member 34, positioned at the second end 25B of the threaded member 25.

Therefore, measuring the distance between the proximity sensor 31 and the reflector member 34 it is possible to detect the position of the threaded member 25 with respect to the fixed end of the box-like member 25C and the distance between the ends 21, 22 of the tubular portions 18, 19 and therefore calculate the range angle α.

In a second embodiment of the sprinkler 1, the electronic control means 28 may comprise at least one first 32 and one second magnetometer 33 positioned spaced apart from each other, respectively at the joint 15 and the spout tube 2 to measure the range angle α.

In a third embodiment of the sprinkler 1, shown in FIGS. 6A and 6B, the drive means 17 comprise an encoder, not shown in the figures, adapted to measure in real time the position of the gear 24 along the threaded member 25 to measure and adjust the range angle α.

To this end, there are provided at least one pair of electronic limit switches 35, 36, positioned respectively in the minimum and maximum stroke positions of the gear 24 along the threaded member 25.

Preferably, the first 35 and the second electronic limit switch 36 are positioned close to the fixed end of the box-like member 25C.

Therefore, the encoder is capable of precisely detecting the position of the second end 25B of the threaded member 25 with respect to the drive means 17 and the distance between the ends 21, 22 of the tubular portions 18, 19 and therefore calculate the range angle α.

Obviously, should there arise the need, the electronic control means 28 may remodulate the position of the gear 24 along the threaded member 25 to change or correct the range angle α.

Furthermore, there is provided a third electronic limit switch 37, positioned in the box-like member 25C in a position comprised between the other two electronic limit switches 35, 36.

In particular, the position of the third electronic limit switch 37 corresponds to a base or initial range angle, preferably comprised between 21° and 27°.

In a per se known manner, such base range angle corresponds to the standard or initial irrigation angle from which the irrigation begins. Obviously, such base or initial range angle may be changed by the user.

Therefore, the base range angle corresponds to the range angle α in which the spout tube 2 is positioned by the electronic control means 28 in case of malfunction or start of the irrigation operations.

The plurality of sensors 31-39 may also comprise a GPS sensor 38, an accelerometer and/or a gyroscope 39.

Preferably, the accelerometer and/or gyroscope 39, are of the known three-axe type and they may be installed in a single inertial measurement electronic component, configured to detect the orientation, the instantaneous direction of the sprinkler and the potential tipping over thereof.

In other words, the inertial measurement electronic component is configured to calculate the yaw, the pitch and the roll of the spout tube 2.

As a matter of fact, the accelerometer and/or the gyroscope 39 is configured to shut off the flow of pressurized water to the spout tube 2 when the latter tips over and/or has a range angle α different from the one set in the memory unit 29.

In such configuration, the irrigation is interrupted and the electronic control means 28 are configured to send an alarm signal to the user.

Therefore, if an operator stores the range angle α on the storage unit 29, the microprocessor 30 of the control means 28 controls the selective activation of the drive means 17 depending on the geographical position of the sprinkler 1, by means of the GPS sensor 38, and/or depending on the position of the irrigation axis of the spout tube 2 calculated by means of a plurality of sensors 31-39.

Advantageously, the electronic control means 28 may be connected by means of wire or wi-fi systems to a device for measuring the strength and the direction of the wind, not shown in the figures, so that the measurement of the speed and/or direction of the wind can allow the instantaneous and continuous change of the range angle α.

Preferably, the control means 28 may be installed on a platform 40 sustained by support means 41 and adapted to contain an electronic board 42 to which there are connected the microprocessor 30, the memory unit 29, the GPS sensor 38 and the inertial measurement electronic component comprising the accelerometer and/or the gyroscope 39.

Obviously, each electrical and/or electronic component of the adjustment system 16 as well as the sprinkler 1 is power-supplied by an electrical power source.

By way of non-limiting example, the electrical power source may comprise at least one battery 43 of the rechargeable and replaceable type, installed on the platform 40.

Furthermore, an antenna for the wireless communication with the control means 28, a temperature sensor or other electronic devices useful for the operation of the adjustment system 16, not shown in the figures, may be installed on the electronic board 42.

For example, the sprinkler 1 may be monitored constantly during the operation thereof by a web server by means of the antenna so as to allow the instantaneous display of the range angle α, the status of all sensors and the control or change of the range angle α

Furthermore, the control means 28 may also comprise a pressure sensor, not shown in the figures, which is fluidically connected to the joint 3, or to a hole obtained on the spout tube 2, to control the actuation of the adjustment system 16 upon reaching a determined pressure of the irrigation water.

In a per se known manner, the sprinkler 1 may be installed on a self-propelled trolley, which moves along a predetermined generally straight path, which defines a virtual movement line along the land to be irrigated.

Generally, the spout tube 2 is pointed towards the direction opposite to the path predetermined by the virtual movement line so that the self-propelled trolley can move along a dry land.

According to a particular operation of the sprinkler 1, when the trolley and the sprinkler 1 are placed on the field to be irrigated, the GPS sensor 38 memorises the initial and final geographical position of the virtual movement line.

Obviously, the distance between the initial and final geographical positions of the virtual movement line corresponds to the length of the unrolled irrigation hose which connects the water supply line to the sprinkler 1.

At this point, the user may set the value of the at least one range angle α in the electronic memory unit 29 depending on the geographical position of the sprinkler 1 along the virtual movement line from the initial position to the final position.

This will allow to upload different irrigation programmes with several range angles α into the electronic memory unit 29 so as to allow the irrigation of land having different slopes or altitudes.

Obviously, the microprocessor 30 of the sprinkler 1 may be connected through GSM, or Lora network, or a proprietary communication module of the user, or through IOT connections to a web platform of the customer.

Such platform will be configured so as to control, through a PC positioned in a geographical location different from that of the field to be irrigated, various irrigation components and machines that form an irrigation system such as for example pumps, various irrigation systems such as center pivot systems, self-propelling trolleys, fixed systems, valves and others.

Furthermore, the platform comprises the option of mapping the geometrical configuration of the land to be irrigated, store the irrigations carried out during an irrigation season and measure the amounts of water used.

According to a further aspect of the invention, there is provided a method for adjusting the range angle α in an impulse sprinkler 1 of the type described above.

The method according to the invention provides a first step a) of storing a range angle α in the electronic control means 28 and a step b) of supplying the sprinkler 1 with pressurized water.

Subsequently, there is provided a step c) of activating the drive means 17, for example for moving the threaded member 25, so as to allow the first 18 and the second tubular portion 19 to slide mutually.

Lastly, there is provided a step d) of instantaneous monitoring of the position of the spout tube 2 through the control means 28 and of the plurality of sensors 31-39 to position the spout tube 2 at the set range angle α.

It should be borne in mind that the range angle α may be set by the user, or by the irrigation map, or change depending on the geographical position of the sprinkler 1 on the mapped land or change instantaneously and continuously depending on the measurement and/or direction of the wind, as described above.

Obviously, the setting of the range angle α may be carried out by the user, storing it in the electronic memory unit 28 or it may be carried out depending on the computer programme of the web platform of the customer or automatically depending on the change in the speed and/or direction of the wind.

It should be observed that in the monitoring step d), when there is detected an instantaneous position of the spout tube 2 having an excessive inclination, measured by the accelerometer and/or the gyroscope 39, for example due to the tipping over of the sprinkler 1, in the method according to the invention there is provided a step e) of shutting off the pressurized water supply.

Such shutting off step e) may comprise sending an alarm signal to the user by means of the electronic control means 28.

In the light of the above it is clear that the sprinkler and the adjustment method according to the invention achieve the pre-established objects and in particular they allow a precise automatic adjustment of the range angle of an impulse sprinkler.

The sprinkler and the method according to the invention are susceptible to numerous modifications and variants all falling within the inventive concept outlined in the attached claims.

Although sprinkler and method have been described with particular reference to the attached figures, the reference numerals used in the description and in the claims are meant for improving the intelligibility of the invention and do not limit the claimed scope of protection in any manner whatsoever.

Throughout the description, reference to “an embodiment” or “the embodiment” or “some embodiments” indicate that a particular characteristic, structure or element described is comprised in at least one embodiment of the object of the present invention.

Furthermore, the particular characteristics, structures or elements may be combined in any appropriate fashion in one or more embodiments.

### INDUSTRIAL APPLICABILITY

The present invention can be applied at industrial level because it can be produced in an industrial scale by industries belonging to the field of irrigation systems for farming and industrial purposes.

The invention claimed is:

1. An impulse sprinkler (1) with an adjustment system (16) for adjusting a range angle (α) of a jet, wherein the impulse sprinkler (1) comprises:
a spout tube (2) connected to a pressurized water supply line for for generating the jet; and
a joint (15) adapted to allow an inclination of the spout tube (2);
wherein the adjustment system (16) comprises drive means (17) associated with said joint (15) to determine the inclination of the spout tube (2), and electronic control means (28) which are selectively connected to said drive means (17) to allow a continuous change in the range angle (α); and
wherein said drive means (17) are a stepper drive adapted to drive a gear (24) movable along a threaded member or a worm screw (25) having a sliding axis (S) coplanar to an axis (R) of said spout tube (2).

2. The impulse sprinkler as claimed in claim 1, wherein said joint (15) comprises a first (18) tubular portion and a second tubular portion (19) connected respectively to the supply line and to said spout tube (2), said first tubular portion and said second tubular portion (18, 19) being pivoted together to rotate around a pin (20) and to slide relative to each other, said drive means (17) comprising a pair of ends (21, 22) connected respectively to said first tubular portion (18) and said second tubular portion (19).

3. The impulse sprinkler as claimed in claim 1, wherein said electronic control means (28) comprise at least one proximity sensor (31) configured to detect a position of said threaded member or said worm screw (25) with respect to said drive means (17) and to measure said range angle (α).

4. The impulse sprinkler as claimed in claim 1, wherein said electronic control means (28) comprise at least one first (32) magnetometer and one second magnetometer (33) positioned spaced apart respectively at said joint (15) and said spout tube (2), said first and said second magnetometers (31, 32) being configured to detect a position of said spout tube (2) and measure said range angle (α).

5. The impulse sprinkler as claimed in claim 1, wherein said drive means (17) comprise an encoder adapted to measure in real time a position of said gear (24) along said threaded member or said worm screw (25).

6. The impulse sprinkler as claimed in claim 5, further comprising at least one pair of electronic limit switches (35, 36) which are positioned respectively in a minimum and a maximum stroke positions of said gear (24) along said threaded member (25).

7. The impulse sprinkler as claimed in claim 1, wherein said electronic control means (28) comprise an electronic storage unit (29) adapted to store a value of the range angle (α) which can be set by a user or by an irrigation map.

8. The impulse sprinkler as claimed in claim 1, wherein said electronic control means (28) comprise an accelerometer and/or a gyroscope (39) configured to shut off a supply of the pressurized water to said spout tube (2) when the spout tube tips over and/or has the range angle (α) different from a preset range angle.

9. The impulse sprinkler as claimed in claim 1, wherein said electronic control means (28) are connected by wire or wi-fi to a device providing a measurement of strength and direction of a wind, said measurement being adapted to instantaneously and continuously change said range angle (α).

10. A method for adjusting a range angle in an impulse sprinkler according to claim 1, method comprising:
a) storing the range angle (α) in said electronic control means (28);
b) supplying the impulse sprinkler (1) with the pressurized water;
c) activating said drive means (17); and
d) monitoring a position of said spout tube (2) with said electronic control means (28) and a plurality of sensors (31-39) to position said spout tube (2) at a preset range angle (α).

11. The method as claimed in claim 10, wherein further comprising of shutting off the pressurized water supply when in said monitoring step d) there is detected an instantaneous position of said spout tube (2) having an excessive inclination.
